(19) United States
(12) Patent Application Publication
(10) Pub. No.: US 2026/0093504 A1
(43) Pub. Date: Apr. 2, 2026

(54) SYSTEMS AND METHODS FOR USING AI TO POPULATE A CUSTOMIZED START UP MENU OUT OF STANDBY

(71) Applicant: DISH Network L.L.C., Englewood, CO (US)

(72) Inventor: Jerome A. LaPalme, Aurora, CO (US)

(21) Appl. No.: 18/900,428

(22) Filed: Sep. 27, 2024

(51) Int. Cl. G06F 9/451; G06F 3/0482; G06F 3/0484

(52) U.S. Cl. CPC G06F 9/451; G06F 3/0482; G06F 3/0484

(57) ABSTRACT

A method for AI based customization of startup menus out of standby in an audio/visual device. This system for User Interface (UI) menu programing includes one or more processors and a memory device storing a set of instructions that, when executed by the one or more processors, causes the one or more processors to: obtain customer history data regarding which menu screens a customer regularly selects; analyze the customer history data using the AI startup menu system to categorize the customer history data; apply the categorized customer history data to a startup menu to organize the customer dictated menu selections; and populate an AI generated startup menu screen based on the customer dictated menu selections for customized and enhanced user experience

### BACKGROUND

Currently, when a user first activates or otherwise “turns on” their television or set-top box system, the original “out of standby” startup menu that first populates is driven by software that presents a traditional tile version on the screen. However, many customers may want further options in addition to the original startup menu format, and would prefer to have their preferences pre-selected to their areas of interest. The customers do not want to go through the inefficiency of being forced to traverse through the traditional menu format and sub-menu format every time they turn on their television or associated set-top box. Some customers may want to go directly to the Program Guide, others may want to go directly to their DVR menu, while still others may want to go to their favorite movie app like Netflix or Prime.

There is a continuing need for a system that can learn a user’s preferences and tendencies. Additionally, there is a continuing need for a system to remove inefficiencies and redundancies from the menus, formats, and layouts, that cause confusion and frustration to users of the system. The present disclosure addresses this and other needs.

### BRIEF SUMMARY

The present disclosure generally relates to using artificial intelligence for customization, and particularly, to using artificial intelligence for customization of startup menus out of standby.

Briefly stated, one or more methods for audio/visual device User Interface (UI) startup menu programing are disclosed. The method includes: obtaining customer history data regarding which menu screens a customer regularly selects; inputting the customer history data into an AI startup menu system; analyzing the customer history data using the AI startup menu system to categorize the customer history data; applying the categorized customer history data to a startup menu to organize customer dictated menu selections; and populating the AI generated startup menu screen based on the customer dictated menu selections for customized and enhanced user experience.

In one or more embodiments, the method for audio/visual device UI startup menu programing further comprises: continuing to obtain additional customer history data regarding which menu screens a customer regularly selects; updating the analysis of the customer history data using the AI startup menu system to revise the categorization of the customer history data; and updating the AI generated startup menu screen based on the additional customer dictated menu selections for customized and enhanced user experience. In another aspect of some embodiments, the method further comprises: applying the categorized customer history data to a startup menu to organize the customer dictated menu selections by day of the week; and populating the AI generated startup menu screen uniquely for each day of the week based on the customer dictated menu selections for each day of the week for daily customized and enhanced user experience.

In still another aspect of some embodiments, the operation of populating the AI generated startup menu screen occurs upon activation of the audio/visual device. The activation of the audio/visual device includes one or more or the audio/visual device being launched, turned on, or coming off of a sleep/standby mode. In yet another aspect of some embodiments, the audio/visual device includes one of a satellite provider application, a satellite receiver, and audio/visual set-top box.

In some embodiments, the AI generated startup menu screen includes direct launch into one or more of on-demand videos, an Apps menu, a streaming platform, recently viewed live TV programing events, recently viewed DVR recording events, sports game finder menu, and guide menu. In another aspect of some embodiments, the AI generated startup menu screen includes direct launch into a Single screen, Dual screen or Quad screen layout. In still another aspect of some embodiments, the AI startup menu system is embedded on an integrated circuit chip. In yet another aspect of some embodiments, the AI startup menu system organizes sub-categories in addition to organization of the AI generated startup menu screen.

In other embodiments, a system for audio/visual device UI menu programing is disclosed. The system includes a memory that stores computer-executable instructions; and a processor that executes the computer-executable instructions that cause the processor to: obtain customer history data regarding which menu screens a customer regularly selects; analyze the customer history data using an AI startup menu system to categorize the customer history data; apply the categorized customer history data to a startup menu to organize customer dictated menu selections; and populate an AI generated startup menu screen based on the customer dictated menu selections for customized and enhanced user experience.

In one or more embodiments of the system for audio/visual device UI menu programing, the memory device stores a set of further instructions that, when executed by the one or more processors, further cause the one or more processors to: continue to obtain additional customer history data regarding which menu screens a customer regularly selects; update the analysis of the customer history data using the AI startup menu system to revise the categorization of the customer history data; and update the AI generated startup menu screen based on the additional customer dictated menu selections for customized and enhanced user experience. In another aspect of the system for audio/visual device UI menu programing, the memory device stores a set of further instructions that, when executed by the one or more processors, further cause the one or more processors to: apply the categorized customer history data to a startup menu to organize the customer dictated menu selections by day of the week; and populate an AI generated startup menu screen uniquely for each day of the week based on the customer dictated menu selections for each day of the week for daily customized and enhanced user experience.

In still another aspect of some embodiments, the operation of populating the AI generated startup menu screen occurs upon activation of the audio/visual device. The activation of the audio/visual device includes one or more or the audio/visual device being launched, turned on, or coming off a sleep/standby mode. In yet another aspect of some embodiments, the audio/visual device includes one of a satellite provider application, a satellite receiver, and audio/visual set-top box.

In some embodiments, the AI generated startup menu screen includes direct launch into one or more of on-demand videos, an Apps menu, a streaming platform, recently viewed live TV programing events, recently viewed DVR recording events, sports game finder menu, and guide menu. In another aspect of some embodiments, the AI generated startup menu screen includes direct launch into a Single screen, Dual screen or Quad screen layout. In still another aspect of some embodiments, the AI startup menu system is embedded on an integrated circuit chip. In yet another aspect of some embodiments, the AI startup menu system organizes sub-categories in addition to organization of the AI generated startup menu screen.

Moreover, in still other embodiments, one or more non-transitory computer-readable storage mediums are disclosed. The one or more non-transitory computer-readable storage mediums have computer-executable instructions stored thereon that, when executed by a processor, cause the processor to: obtain customer history data regarding which menu screens a customer regularly selects; input the customer history data into an AI menu system; analyze the customer history data using the AI menu system to categorize the customer history data; apply the categorized customer history data to a menu to organize customer dictated menu selections; and populate an AI generated menu screen based on the customer dictated menu selections for customized and enhanced user experience.

In another aspect of some embodiments of the system, the non-transitory computer-readable storage medium includes further computer-executable instructions that, when executed by a processor, cause the processor to: continue to obtain additional customer history data regarding which menu screens a customer regularly selects; update the analysis of the customer history data using the AI menu system to revise the categorization of the customer history data; and update the AI generated menu screen based on the additional customer dictated menu selections for customized and enhanced user experience.

In still another aspect of some embodiments of the system, the non-transitory computer-readable storage medium includes further computer-executable instructions that, when executed by a processor, cause the processor to: apply the categorized customer history data to a menu to organize the customer dictated menu selections by day of the week; and populate an AI generated menu screen uniquely for each day of the week based on the customer dictated menu selections for each day of the week for daily customized and enhanced user experience.

### BRIEF DESCRIPTION OF THE DRAWINGS

The components in the drawings are not necessarily to scale relative to each other. Like reference numerals designate corresponding parts throughout the several views.

FIG. 1A is an AI generated startup menu architecture, according to one example embodiment.

FIG. 1B is an AI generated startup menu operational flow, according to one example embodiment.

FIG. 2A is a standard startup menu screen with the On Demand selection highlighted in the top row of the startup menu.

FIG. 2B is another view of the standard startup menu screen with the Sign Off selection highlighted in the second row of the startup menu.

FIG. 2C is still another view of the standard startup menu screen with the Unang Hirit selection highlighted in the “My Recordings” row of the startup menu.

FIG. 3 is an AI generated startup menu showing a top movies launch screen that was generated using historical customer input selection data, according to one example embodiment.

FIG. 4 is an AI generated startup menu showing a Prime launch screen that was generated using historical customer input selection data, according to one example embodiment.

FIG. 5 is an AI generated startup menu showing a launch Apps menu screen that was generated using historical customer input selection data, according to one example embodiment.

FIG. 6 is an AI generated startup menu showing a launch DVR menu screen that was generated using historical customer input selection data, according to one example embodiment.

FIG. 7 is an AI generated startup menu showing a launch guide screen that was generated using historical customer input selection data, according to one example embodiment.

FIG. 8 is an AI generated startup menu showing a launch Game Finder screen that was generated using historical customer input selection data, according to one example embodiment.

FIG. 9 is an AI generated startup menu showing a launch Single screen with Picture-In-Picture (PiP) screen that was generated using historical customer input selection data, according to one example embodiment.

FIG. 10A is an AI generated startup menu showing a launch Dual screen that was generated using historical customer input selection data, according to one example embodiment.

FIG. 10B is an AI generated startup menu showing a launch Quad screen that was generated using historical customer input selection data, according to one example embodiment.

FIG. 11 is a logic diagram showing operations flow during UI menu programing of the audio/visual device.

FIG. 12 shows a system diagram that describes an example implementation of a computing system(s) for implementing embodiments described herein.

### DETAILED DESCRIPTION

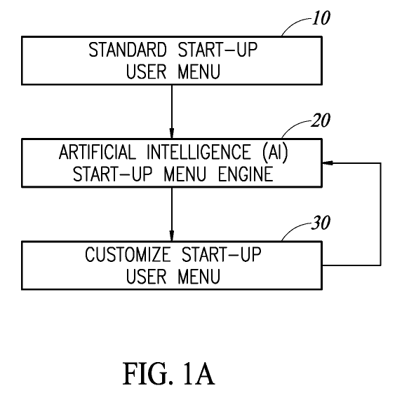

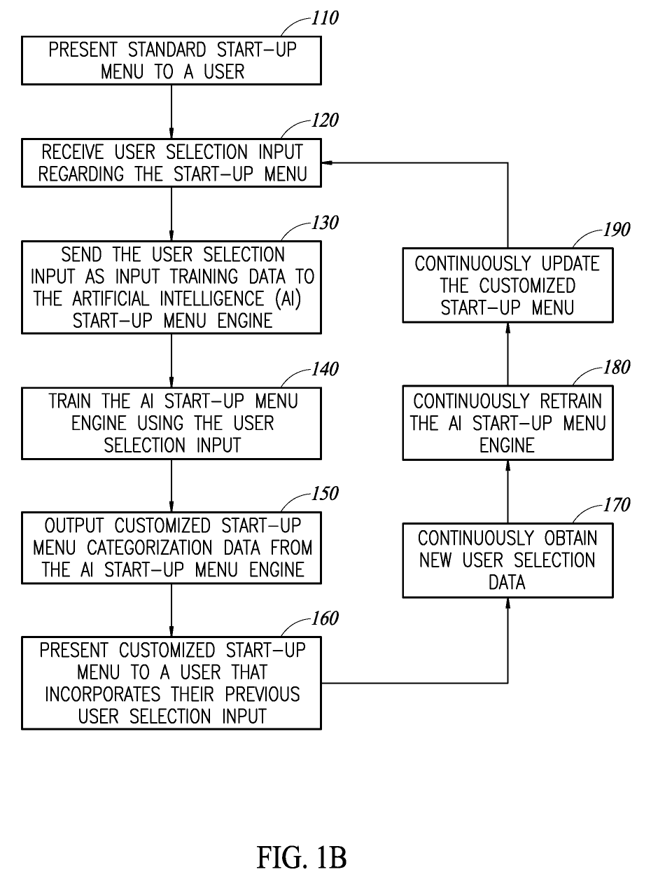

Each of the features and teachings disclosed herein may be utilized separately or in conjunction with other features and teachings to provide a system for AI based customization of startup menus out of standby. Representative examples utilizing many of these additional features and teachings, both separately and in combination, are described in further detail with reference to the attached FIGS. 1A-12. This detailed description is intended to teach a person of skill in the art further details for practicing aspects of the present teachings and is not intended to limit the scope of the claims. Therefore, combinations of features disclosed in the detailed description may not be necessary to practice the teachings in the broadest sense, and are instead taught merely to describe particularly representative examples of the present teachings. In some embodiments, the system for AI based customization of startup menus out of standby includes an application program interface that enables users to control certain customer service activities with respect to live broadcast, recorded, streaming and on-demand programming using vocal commands in a customer service control system.

The following description, along with the accompanying drawings, sets forth certain specific details to provide a thorough understanding of various disclosed embodiments. However, one skilled in the relevant art will recognize that the disclosed embodiments may be practiced in various combinations, without one or more of these specific details, or with other methods, components, devices, materials, and the like. In other instances, well-known structures or components that are associated with the environment of the present disclosure, including but not limited to the communication systems and networks, have not been shown or described to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” includes singular and plural references.

Referring to FIGS. 1A and 1B, the system for AI based customization of startup menus out of standby also obtains and establishes many user attributes at the beginning of a session. In various embodiments, the system for AI based customization of startup menus uses customer history data regarding menu preference selections to drive which menus it populates first (e.g., from standby mode), instead of beginning with a standard startup menu 10. In such embodiments, an Artificial Intelligence (AI) startup menu engine 20 uses the customer history data regarding menu preference selections to improve the operational efficiency (and reduce latencies), thereby enabling the customer to navigate to the intended menu with greater operational efficiency. The AI Start-Up Menu Engine 20 effectively takes the customer history data regarding menu preference selections, from which menu screens a customer regularly selects, categorizes the data, and then uses the output data to populate a customized startup menu 30 of the highest menu selections, for that particular customer, the next time the receiver comes out of standby or is otherwise launched. Thus, if a customer most frequently goes to Live TV (or free streaming Apps), then the customer will initially be presented with Live TV, instead of being delayed with a series of menu button choices, as well as potentially username and password requirements, mandatory initial commercial requirements, or other operational delays caused by some platforms or applications.

Referring again to FIGS. 1A and 1B, an AI generated startup menu architecture and operational flow is shown. At operation 110, a standard startup menu 10 is presented to a user. At operation 120, user selection input is received regarding the startup menu. At operation 130, the user selection input is sent as input training data to the Artificial Intelligence (AI) startup menu engine 20. At operation 140, the AI startup menu engine 20 is trained using the user selection input. At operation 150, the customized startup menu categorization data is output from the AI startup menu engine 20. At operation 160, the customized startup menu 30 is presented to the individual user that incorporates that user’s previous user selection input. Beginning at operations 170, 180, and 190, a continuous loop is created by obtaining updated user selection data, retraining the AI startup menu engine 20 with that data, and re-customizing the startup menu 30. Accordingly, at operation 170, the AI generated startup menu system obtains updated user selection data. Next, at operation 180, the AI generated startup menu system continuously retrains the AI startup menu engine 20. Finally, at operation 190, the AI generated startup menu system 20 continuously updates the customized startup menu 30 using the output of the AI startup menu engine 20 that was retrained by the updated user selection data.

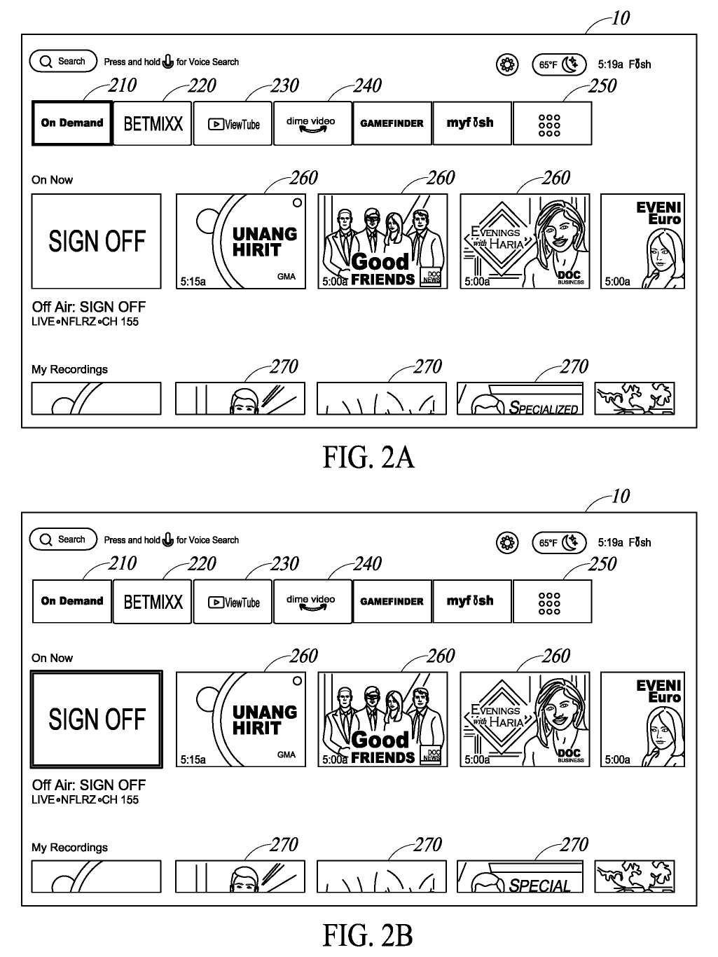

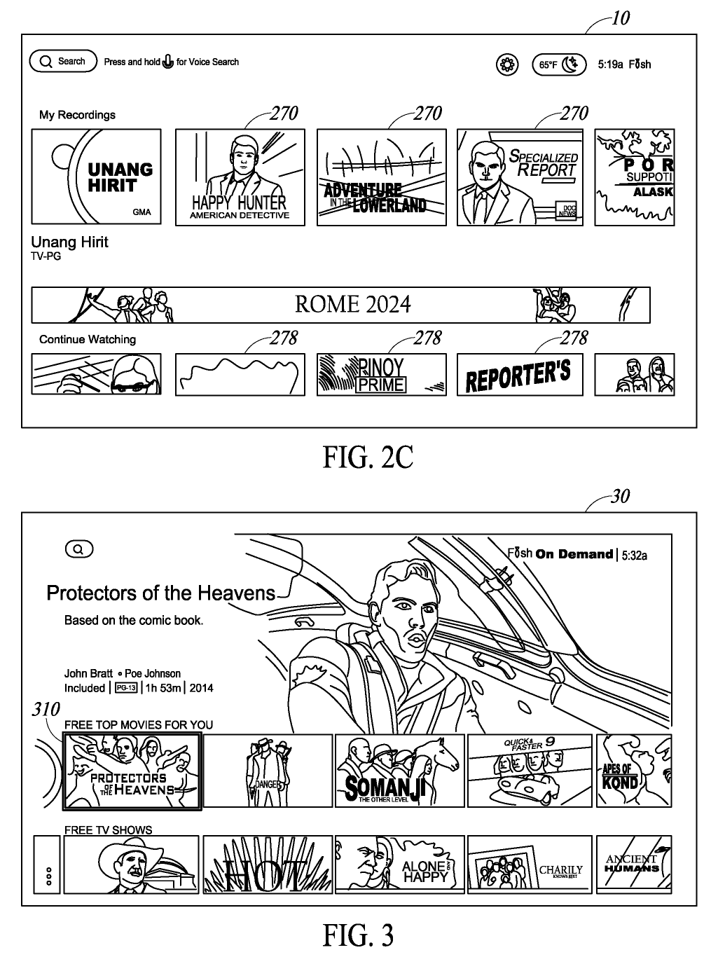

Referring now to FIGS. 2A, 2B, and 2C, a User Interface (UI) for a standard startup menu 10 is shown that includes the same format and layout, namely, a lineup of menu button selections (e.g., On Demand 210, Netflix 220, YouTube 230, Prime 240, an Apps menu 250, etc.), recently shown live TV programing events 260, recently recorded DVR recording events 270, recently viewed DVR recording events 278 (i.e., “continue watching” events), and the like. Figure 2A shows the On Demand selection highlighted in the top row of the startup menu. Figure 2B shows the Sign Off selection highlighted in the second row of the startup menu. FIG. 2C shows the Unang Hirit selection highlighted in the “My Recordings” row of the startup menu.

As described above, in one or more embodiments of the system for AI based customization of startup menus, this standard startup menu 10 may be replaced with a customized startup menu 30 that is tailored to the selection behavior of an individual customer. In this manner, the system uses an Artificial Intelligence (AI) startup menu engine 20 to generate the customized startup menu 30 that enables a user to go directly to its most frequently used selection, based on that individual customer’s history data. In such an embodiment, the software programming of the receiving/presenting device works in unison with the AI startup menu engine 20, and presents the output categorization data directly to the customized startup menu 30, which includes the user’s most used feature selection buttons, upon startup the device.

For example, in one such embodiment of a customized startup menu 30 as shown in FIG. 3, the receiving/presentation device (e.g., set-top box, application, mobile device, smart television, etc.) directly presents a top movies On Demand launch menu 310 to the customer, based on the individual customer history selection data. In this embodiment, a customer whose top menu selection preference may be identified by the AI startup menu engine 20 using the customer’s history data of menu selections, is able to launch directly to a top movies On Demand startup menu.

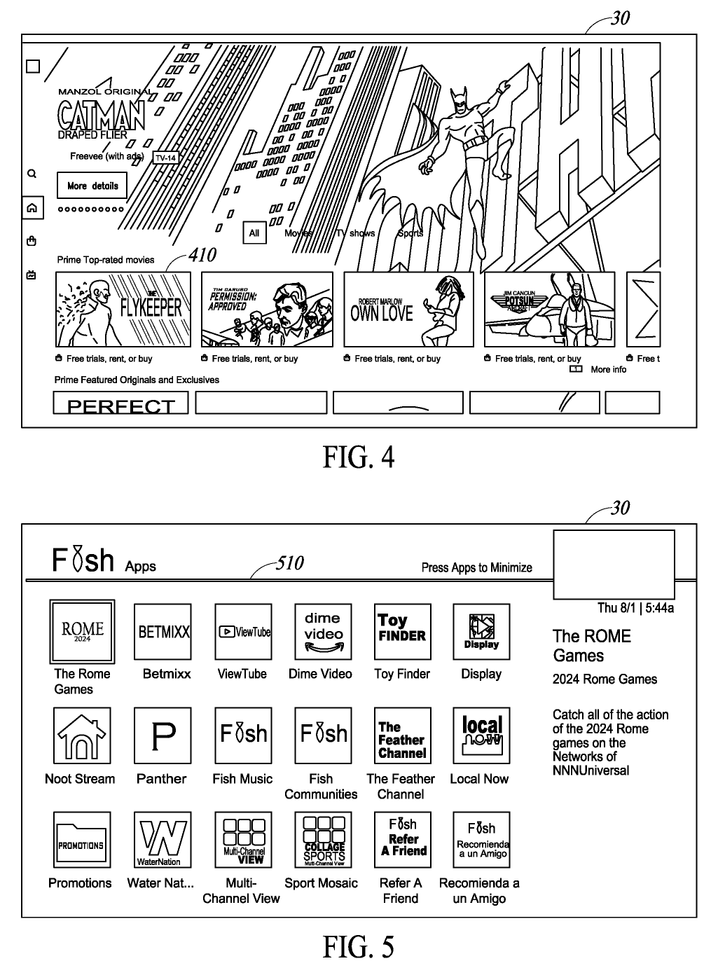

In another such embodiment of a customized startup menu 30 as shown in FIG. 4, the receiving/presentation device directly presents a Prime movies launch menu 410 to the customer, based on the individual customer history selection data. In this embodiment, a customer whose top menu selection preference may be identified by the AI startup menu engine 20 using the customer’s history data of menu selections, is able to launch directly to a Prime movies startup menu. In another implementation, the customer menu selection preference may be identified by the AI startup menu engine 20 using the customer’s history data of menu selections, as a Netflix platform startup menu.

In still another embodiment of a customized startup menu 30 as shown in FIG. 5, the receiving/presentation device directly presents an Apps platform launch menu 510 to the customer, based on the individual customer history selection data. In this embodiment, a customer whose top menu selection preference may be identified by the AI startup menu engine 20 using the customer’s history data of menu selections, is able to launch directly to an Apps platform startup menu. In another implementation, the customer menu selection preference may be identified by the AI startup menu engine 20 using the customer’s history data of menu selections, as a Weather channel App startup menu.

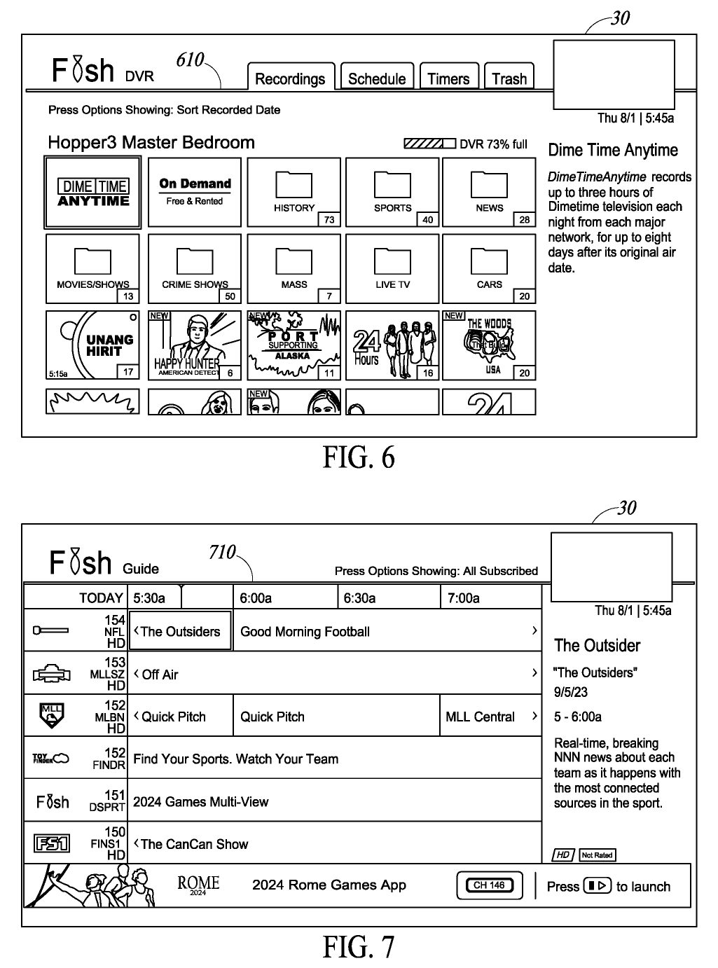

In yet another embodiment of a customized startup menu 30 as shown in FIG. 6, the receiving/presentation device directly presents a DVR menu 610 to the customer, based on the individual customer history selection data, for an individual customer who only wants to watch previously recorded events, shows, or movies. In this embodiment, a customer whose top menu selection preference may be identified by the AI startup menu engine 20 using the customer’s history data of menu selections, is able to launch directly to a DVR startup menu.

Further, in one or more embodiments of a customized startup menu 30 as shown in FIG. 7, the receiving/presentation device directly presents a Guide launch menu 710 to the customer, based on the individual customer history selection data. In this embodiment, a customer whose top menu selection preference may be identified by the AI startup menu engine 20 using the customer’s history data of menu selections, is able to launch directly to a Guide startup menu.

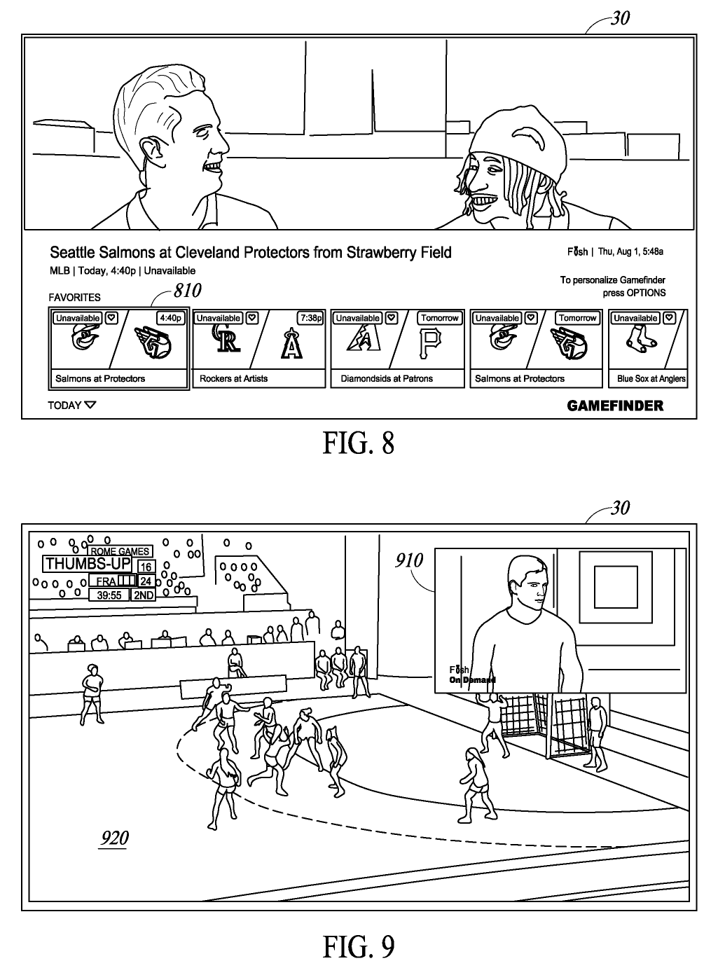

Moreover, in some embodiments of a customized startup menu 30 as shown in FIG. 8, the receiving/presentation device directly presents a Game Finder launch menu 810 to the customer, based on the individual customer history selection data. In this embodiment, a customer whose top menu selection preference may be identified by the AI startup menu engine 20 using the customer’s history data of menu selections, is able to launch directly to a Game Finder startup menu. In this manner, any current menu choice of the user may be launched directly when the device is turned on, or comes out of standby mode.

Referring now to FIG. 9, in this embodiment the AI startup menu engine 20 is able to select the top two menu selections of the customer using historical customer input selection data, instead of only one, since this embodiment directly presents a single screen with Picture-In-Picture (PiP) 910 to the customer. Thus, the customer’s first menu selection, as determined by the AI startup menu engine 20 using the historical customer input selection data, may be shown on the main screen 920 and the customer’s second menu selection, as determined by the AI startup menu engine 20 using the historical customer input selection data, may be shown in the Picture-in-Picture window. In this manner, the system for AI based customization of startup menus increases operational efficiency and reduces latency regarding optimized customer programming, using the AI startup menu engine 20 driven approach.

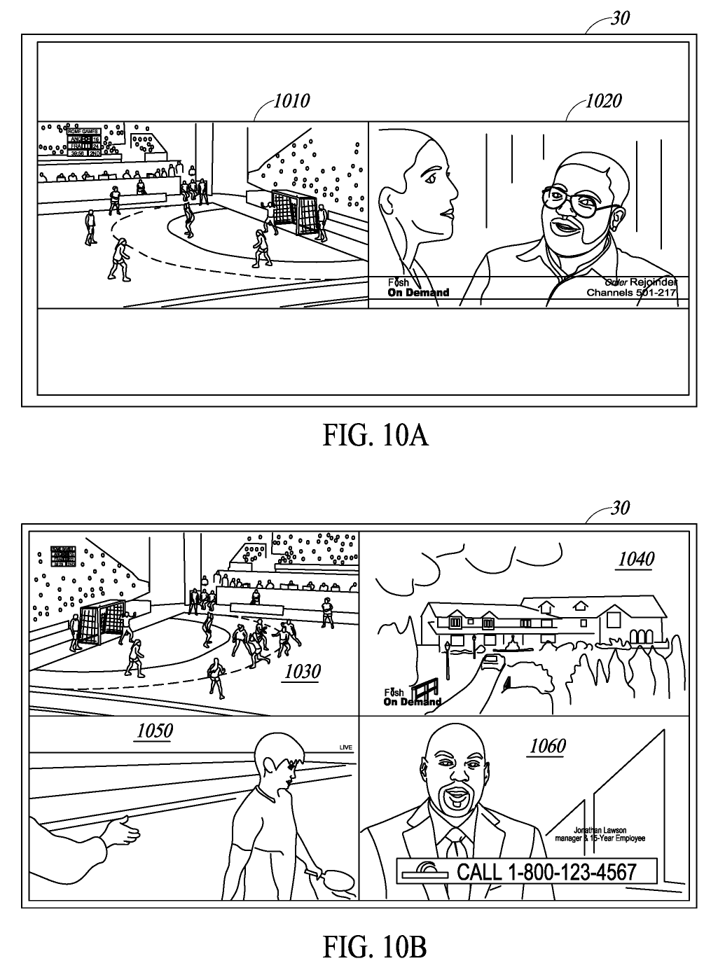

Referring now to FIGS. 10A and 10B, in these embodiments the AI startup menu engine 20 is able to select the top two menu selections of the customer using historical customer input selection data for a Split screen menu 1010, 1020 (as shown in FIG. 10A) or the AI startup menu engine 20 is able to select the top four menu selections of the customer using historical customer input selection data for a Quad menu 1030, 1040, 1050, 1060 (as shown in FIG. 10B) of user interface selections for the customer. For example, in a Quad menu of user interface selections, one startup screen presents four targeted customer data driven preference choices, without having to physically select any options with the remote control (or any additional sub-categories), since the top four user interface selections are pre-populated on device start-up. Otherwise stated, a split screen startup menu or a quad screen startup menu may be used by the AI startup menu engine 20 to launch a dual screen or quad screen layout for the customized startup menu 30, thereby increasing operational efficiency and latency reduction. The AI startup menu engine 20 sends the analyzed and categorized customer history data to pre-populate the preferences of the customized startup menu 30 on the device’s startup menu.

In the embodiments discussed above with respect to FIGS. 3-10B, customized startup menus 30 are discussed for the categorization of the initial launch page. In other embodiments, AI startup menu engine 20 is used to organize subcategories of movies, shows, and events, as well as the categories on the initial startup launch screen.

In some embodiments of the system for AI based customization of startup menus, the AI startup menu engine 20 is embedded in an Integrated Circuit (IC) chip. In other embodiments of the system for AI based customization of startup menus, the AI startup menu engine 20 is cloud-based software. In still other embodiments of the system for AI based customization of startup menus, the AI startup menu engine 20 is a combination of embedded AI and cloud-based AI.

Since the system for AI based customization of startup menus is continuously updating the AI startup menu engine 20 with the user history information that the system obtains, the system continues to evolve with a user’s viewing and selection habits as those viewing and selection habits evolve. In this manner, the system for AI based customization of startup menus is able to predict future behavior of the customer using pattern recognition. For example, in some embodiments, the AI startup menu engine 20 creates different customized startup menus 30 for different days of the week or days of the month. In one such embodiment, the AI startup menu engine 20 recognizes that the customer wants news programming to be prioritized on the customized startup menu 30 during the weekdays, and movie programming to be prioritized on the customized startup menu 30 on the weekends. In another such embodiment, the AI startup menu engine 20 recognizes that the customer wants NFL football programming to be prioritized on the customized startup menu 30 on Monday evenings, Thursday evenings, and Sunday all day, while movie programming is prioritized on the customized startup menu 30 on all remaining time periods. In this regard, in still another such embodiment, the AI startup menu engine 20 recognizes that the customer wants You Tube programming to be prioritized on the customized startup menu 30 during the daytime (e.g., 9 a.m.-5 p.m.), while Netflix programming is prioritized on the customized startup menu 30 on all remaining time periods (e.g., 5 p.m.-9 a.m.). In yet other embodiments, the system for AI based customization of startup menus uses a user’s viewing and selection habits in conjunction with pattern recognition to categorize the customized startup menu 30 according to one or more of sports season schedule, television series season schedule, favorite show schedule, and favorite genre.

In another aspect of some embodiments, the system for AI based customization of startup menus examines only the top selection of user input, when sending information to the AI startup menu engine 20. In still another aspect of some embodiments, the system for AI based customization of startup menus examines the top three selections of user input, when sending information to the AI startup menu engine 20. In yet another aspect of some embodiments, the system for AI based customization of startup menus examines the top ten selections of user input, when sending information to the AI startup menu engine 20.

In some embodiments of the system for AI based customization of startup menus, the customized startup menu 30 is populated to be user-specific, instead of television-specific, set-top box-specific, or other receiving/presenting device-specific. In one such embodiment, each user has their own remote control device with an associated code that identifies the user linked to the customized startup menu 30. In another such embodiment, a single remote control device has settings for multiple users, each user setting having an associated code that identifies the user linked to the customized startup menu 30. In still another such embodiment, the remote control device has a biometric receiving system (retinal scanner, fingerprint reader, etc.) that enables different users to be identified, each user having their own associated code that identifies the user linked to the customized startup menu 30.

Additionally, more and more streaming platforms are beginning to have mandatory commercials to be watched when the platform is first launched. Thus, if a user has to navigate through multiple applications or platforms to reach their desired destination, this may cause an operational delay of one or more minutes, which is an unacceptably long latency period. With the system for AI based customization of startup menus, customers reach their preferred streaming platform and/or program selection faster, instead of navigating through menu after menu. Additionally, sometimes streaming platforms have mandatory password-protected login requirements every time the platform is launched. This can be challenging for users that do not readily remember their passwords or who have remote controls that are difficult and time-consuming to use for entry of usernames and passwords. Accordingly, by using a customized startup menu 30 that begins in a user’s preferred streaming platform, such username and password entry requirements may be avoided or minimized in some embodiments of the system.

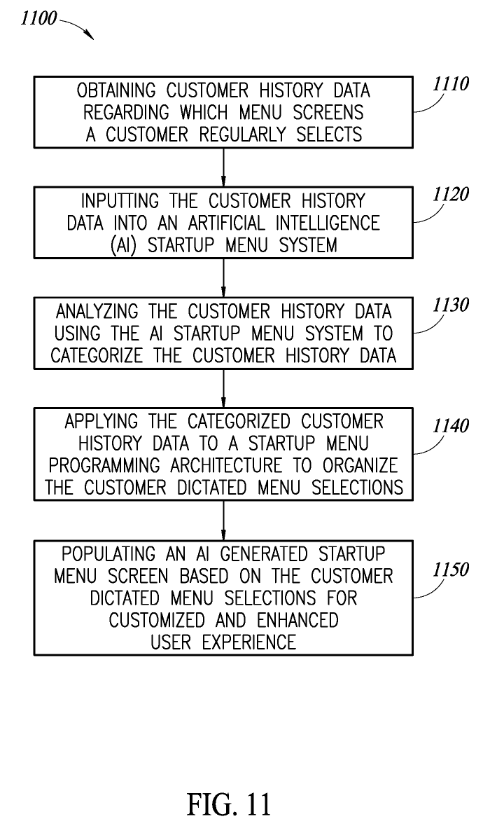

FIG. 11 is a logic diagram showing a method for audio/visual device UI menu programing 1000. As shown in FIG. 11, at operation 1110, the method includes obtaining customer history data regarding which menu screens a customer regularly selects. At operation 1120, the method includes inputting the customer history data into an Artificial Intelligence (AI) startup menu system. At operation 1130, the method includes analyzing the customer history data using the AI startup menu system to categorize the customer history data. At operation 1140, the method includes applying the categorized customer history data to a startup menu to organize the customer dictated menu selections. At operation 1150, the method includes populating the AI generated startup menu screen based on the customer dictated menu selections for customized and enhanced user experience.

In the content distribution environment, audio, video, and/or data service providers, such as television service providers, provide their customers a multitude of video and/or data programming (herein, collectively “programming”). Such programming is often provided by use of a receiving device (e.g., in some embodiments referred to as a hopper) communicatively coupled to a presentation device configured to receive the programming. In one or more embodiments, the receiving device is dynamically controlled by the system for AI based customization of startup menus out of standby. The programming may include any type of media content, including, but not limited to: television shows, news, movies, sporting events, advertisements, etc. In various embodiments, any of this programming may be provided as a type of programming referred to as streaming media content, which is generally digital multimedia data that is substantially constantly received by and presented to an end user or presented on a device while being delivered by a provider from a stored file source. Its verb form, “to stream,” refers to the process of delivering media in this manner. The term refers to how the media is delivered rather than the media itself.

Examples of a receiving device may include, but are not limited to, devices such as, or any combination of: a “television converter,” “receiver,” “set-top box,” “television receiving device,” “television receiver,” “television,” “television recording device,” “satellite set-top box,” “satellite receiver,” “cable set-top box,” “cable receiver,” “media player,” “digital video recorder (DVR),” “digital versatile disk (DVD) Player,” “computer,” “mobile device,” “tablet computer,” “smartphone,” “MP3 Player,” “handheld computer,” and/or “television tuner,” etc. Accordingly, the receiving device may be any suitable converter device or electronic equipment that is operable to receive programming via a connection to a satellite or cable television service provider outside the customer premises and communicate that programming to another device over a network. Further, the receiving device may itself include user interface devices, such as buttons or switches. In some example embodiments, the receiving device may be configured to receive and decrypt content according to various digital rights management (DRM) and other access control technologies and architectures.

Examples of a presentation device may include, but are not limited to, one or a combination of the following: a television (TV), a personal computer (PC), a sound system receiver, a digital video recorder (DVR), a compact disk (CD) device, DVD Player, game system, tablet device, smartphone, mobile device or other computing device or media player, and the like. Presentation devices employ a display, one or more speakers, and/or other output devices to communicate video and/or audio content to a user. In many implementations, one or more presentation devices reside in or near a customer’s premises and are communicatively coupled, directly or indirectly, to the receiving device. Further, the receiving device and the presentation device may be integrated into a single device. Such a single device may have the above-described functionality of the receiving device and the presentation device, or may even have additional functionality.

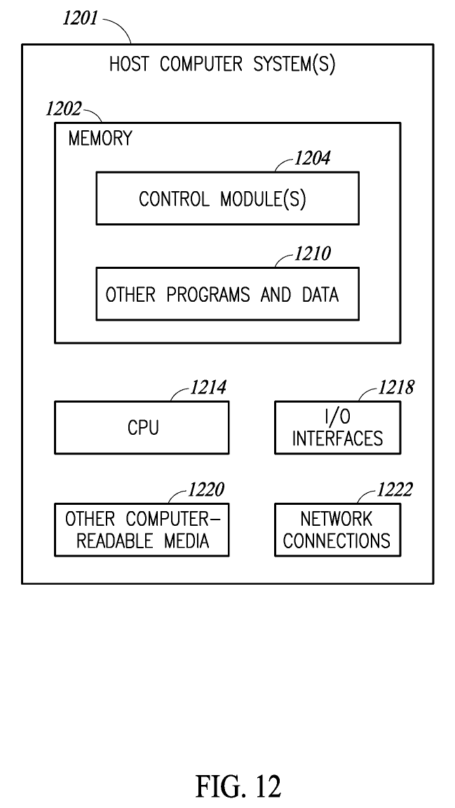

FIG. 12 shows a system diagram that describes an example implementation of a computing system(s) for implementing embodiments described herein. The functionality described herein for a system for providing emergency IoT service without subscriber identity of network registration in mobile networks, can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that it is agnostic to the underlying cloud infrastructure, allowing higher deployment agility and flexibility.

In particular, shown is example host computer system(s) 1201. For example, such computer system(s) 1201 may represent those in various data centers and cell sites shown and/or described herein that host the functions, components, microservices and other aspects described herein to implement a system for providing emergency IoT service without subscriber identity of network registration in mobile networks. In some embodiments, one or more special-purpose computing systems may be used to implement the functionality described herein. Accordingly, various embodiments described herein may be implemented in software, hardware, firmware, or in some combination thereof. Host computer system(s) 1201 may include memory 1202, one or more central processing units (CPUs) 1214, I/O interfaces 1218, other computer-readable media 1220, and network connections 1222.

Memory 1202 may include one or more various types of non-volatile and/or volatile storage technologies. Examples of memory 1202 may include, but are not limited to, flash memory, hard disk drives, optical drives, solid-state drives, various types of random-access memory (RAM), various types of read-only memory (ROM), other computer-readable storage media (also referred to as processor-readable storage media), or the like, or any combination thereof. Memory 1202 may be utilized to store information, including computer-readable instructions that are utilized by CPU 1214 to perform actions, including those of embodiments described herein.

Memory 1202 may have stored thereon control module(s) 1204. The control module(s) 1204 may be configured to implement and/or perform some or all of the functions of the systems, components and modules described herein for a system for providing emergency IoT service without subscriber identity of network registration in mobile networks. Memory 1202 may also store other programs and data 1210, which may include rules, databases, application programming interfaces (APIs), software platforms, cloud computing service software, network management software, network orchestrator software, network functions (NF), AI or ML programs or models to perform the functionality described herein, user interfaces, operating systems, other network management functions, other NFs, etc.

Network connections 1222 are configured to communicate with other computing devices to facilitate the functionality described herein. In various embodiments, the network connections 1222 include transmitters and receivers (not illustrated), cellular telecommunication network equipment and interfaces, and/or other computer network equipment and interfaces to send and receive data as described herein, such as to send and receive instructions, commands and data to implement the processes described herein. I/O interfaces 1218 may include a video interface, other data input or output interfaces, or the like. Other computer-readable media 1220 may include other types of stationary or removable computer-readable media, such as removable flash drives, external hard drives, or the like.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for Artificial Intelligence (AI)-based User Interface (UI) menu programing, the method comprising:
obtaining customer history data regarding which menu screens a customer regularly selects;
inputting the customer history data into an AI startup menu system;
analyzing the customer history data using the AI startup menu system to categorize the customer history data;
applying the categorized customer history data to a startup menu to organize customer dictated menu selections; and
populating an AI generated startup menu screen based on the customer dictated menu selections for customized and enhanced user experience.

2. The method of claim 1, further comprising:
continuing to obtain additional customer history data regarding which menu screens a customer regularly selects;
updating the analysis of the customer history data using the AI startup menu system to revise the categorization of the customer history data; and
updating the AI generated startup menu screen based on the additional customer dictated menu selections for customized and enhanced user experience.

3. The method of claim 1, further comprising:
applying the categorized customer history data to a startup menu to organize the customer dictated menu selections by day of the week; and
populating the AI generated startup menu screen uniquely for each day of the week based on the customer dictated menu selections for each day of the week for daily customized and enhanced user experience.

4. The method of claim 1, wherein populating the AI generated startup menu screen occurs upon activation of the audio/visual device, and wherein activation of the audio/visual device includes one or more of the audio/visual device being launched, turned on, or coming off a sleep/standby mode.

5. The method of claim 1, wherein the audio/visual device includes one of a satellite provider application, a satellite receiver, and audio/visual set-top box.

6. The method of claim 1, wherein the AI generated startup menu screen includes direct launch into one or more of on-demand videos, an Apps menu, a streaming platform, recently viewed live TV programing events, recently viewed DVR recording events, sports game finder menu, and guide menu.

7. The method of claim 1, wherein the AI generated startup menu screen includes direct launch into a Single screen, Dual screen or Quad screen layout.

8. The method of claim 1, wherein the AI startup menu system is embedded on an integrated circuit chip.

9. The method of claim 1, wherein the AI startup menu system organizes sub-categories in addition to organization of the AI generated startup menu screen.

10. A system for Artificial Intelligence (AI)-based User Interface (UI) menu programing, the system comprising:
one or more processors; and
a memory device storing a set of instructions that, when executed by the one or more processors, causes the one or more processors to:
obtain customer history data regarding which menu screens a customer regularly interacts;
analyze the customer history data using an AI startup menu system to categorize the customer history data;
apply the categorized customer history data to a startup menu to organize customer dictated menu selections; and
populate an AI generated startup menu screen based on the customer dictated menu selections for customized and enhanced user experience.

11. The system of claim 10, wherein the memory device stores a set of further instructions that, when executed by the one or more processors, further cause the one or more processors to:
continue to obtain additional customer history data regarding which menu screens a customer regularly selects;
update the analysis of the customer history data using the AI startup menu system to revise the categorization of the customer history data; and
update the AI generated startup menu screen based on the additional customer dictated menu selections for customized and enhanced user experience.

12. The system of claim 10, wherein the memory device stores a set of further instructions that, when executed by the one or more processors, further cause the one or more processors to:
apply the categorized customer history data to a startup menu to organize the customer dictated menu selections by day of the week; and
populate an AI generated startup menu screen uniquely for each day of the week based on the customer dictated menu selections for each day of the week for daily customized and enhanced user experience.

13. The system of claim 10, wherein populating the AI generated startup menu screen occurs upon activation of the audio/visual device, and wherein activation of the audio/visual device includes one or more of the audio/visual device being launched, turned on, or coming off a sleep/standby mode.

14. The system of claim 10, wherein the AI generated startup menu screen includes direct launch into one or more of on-demand videos, an Apps menu, a streaming platform, recently viewed live TV programing events, recently viewed DVR recording events, sports game finder menu, and guide menu.

15. The system of claim 10, wherein the AI generated startup menu screen includes direct launch into a Single screen, Dual screen, or Quad screen layout, based on historical data of the customer dictated menu selections.

16. The system of claim 10, wherein the AI startup menu system is embedded on an integrated circuit chip.

17. The system of claim 10, wherein the AI startup menu system organizes sub-categories in addition to organization of the AI generated startup menu screen.

18. A non-transitory computer-readable storage medium having computer-executable instructions stored thereon that, when executed by a processor, cause the processor to:
obtain customer history data regarding which menu screens a customer regularly selects;
input the customer history data into an AI menu system;
analyze the customer history data using the AI menu system to categorize the customer history data;
apply the categorized customer history data to a menu to organize customer dictated menu selections; and
populate an AI generated menu screen based on the customer dictated menu selections for customized and enhanced user experience.

19. The non-transitory computer-readable storage medium of claim 18, wherein computer-executable instructions stored thereon that, when executed by a processor, cause the processor to:
continue to obtain additional customer history data regarding which menu screens a customer regularly selects;
update the analysis of the customer history data using the AI menu system to revise the categorization of the customer history data; and
update the AI generated menu screen based on the additional customer dictated menu selections for customized and enhanced user experience.

20. The non-transitory computer-readable storage medium of claim 18, wherein computer-executable instructions stored thereon that, when executed by a processor, cause the processor to:
apply the categorized customer history data to a menu to organize the customer dictated menu selections by day of the week; and
populate an AI generated menu screen uniquely for each day of the week based on the customer dictated menu selections for each day of the week for daily customized and enhanced user experience.
